(19) United States
(12) Patent Application Publication
(10) Pub. No.: US 2017/0178183 A1
(43) Pub. Date: Jun. 22, 2017

(54) AUTOMATIC EVENT PROMOTION SYSTEM

(71) Applicant: Reza RAJI, Menlo Park, CA (US)

(72) Inventor: Reza RAJI, Menlo Park, CA (US)

(21) Appl. No.: 15/223,269

(22) Filed: Jul. 29, 2016

Related U.S. Application Data
(60) Provisional application No. 62/199,312, filed on Jul. 31, 2015.

(51) Int. Cl. G06Q 30/02; G06Q 50/00; H04W 4/08; G06F 17/30

(52) U.S. Cl. CPC G06Q 30/0252; G06F 17/30702; G06Q 50/00; H04W 4/08; G06F 17/30699; G06Q 30/02; G06Q 30/0251; G06Q 30/0254

(57) ABSTRACT

Embodiments include a platform and/or application configured to select an event on a first electronic site using a source device, and integrate with a presentation of the event a selector for a micropromotion application. An invitation to the event is automatically generated at the source device in response to selection of the selector. Invitees are added to the invitation from at least one of a social media application and a contact application coupled to the source device. The invitation is configured to include a reply link, and the reply link is configured to generate a reply to the source device. The reply link is configured to generate, via one or more third party platforms, presentation of service offers at the source device and invitee devices of the invitees. The service offers include offers of services of the event provider and services related to the event.

### RELATED APPLICATION

This application claims the benefit of U.S. Patent Application No. 62/199,312, filed Jul. 31, 2015.

### TECHNICAL FIELD

The embodiments described herein relate generally to applications for computer processing and, more particularly, to automatic event promotion using applications and other processing components.

### BACKGROUND

There is a need for a system to improve the efficiency of coordination among parties when planning activities and events.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a flow diagram for event processing, under an embodiment.

FIG. 2 shows example screenshots of the MicroPromotion event promotion process, under an embodiment.

FIG. 3 is an example screen flow for event processing, under an embodiment.

### DETAILED DESCRIPTION

Embodiments include an event promotion (also referred to herein as “MicroPromotion”) system comprising applications and other processing components in a processing environment. The system comprises a platform including at least one processor coupled to one or more memory devices or databases. A MicroPromotion networking component or application executes on a remote device and through communication with the platform provides the interactions described in detail herein.

Embodiments of the event promotion system include a platform and/or application configured to select an event on a first electronic site using a source device, and integrate with a presentation of the event a selector for a micropromotion application. An invitation to the event is automatically generated at the source device in response to selection of the selector. Invitees are added to the invitation from at least one of a social media application and a contact application coupled to the source device. The invitation is configured to include a reply link, and the reply link is configured to generate a reply to the source device. The reply link is configured to generate, via one or more third party platforms, presentation of service offers at the source device and invitee devices of the invitees. The service offers include offers of services of the event provider and services related to the event.

MicroPromotion of an embodiment is an easy way to plan get-togethers with others. The “SnapChat meets Evite” model simplifies the conventional process of getting together with friends or family for activities and events (e.g., parties, drinks, concerts, dinners, hikes, poker games, golf, etc.). Conventional planning tools are cumbersome and heavy, which make quick, small get-togethers tedious to arrange. Group text is inadequate, chatty and boring. Details are easily lost, those who opt out are annoyed, and adding a new guest is somewhat difficult. Cross-platform issues between Android and iPhone users also arise under conventional messaging techniques.

MicroPromotion described herein solves these problems by using photos and videos to create simple and quick personal invitations, making coordination among people personalized and engaging for users. Users hosting the MicroPromotion application on their devices (e.g., phones, tablets, etc.) can create a plan and invite anyone with a device identification (e.g., cell phone number, messaging identification, etc.) to join the plan. MicroPromotion is also configured as a planning engine for event promoters and curators who want to extend the reach of an event. The smartphone's prolific presence allows people of all ages to fulfill their ever-present desire of getting together with others.

Upon downloading the application to his or her phone, a user receives a single text from the MicroPromotion platform to verify identity during setup. Thereafter, all communication is handled via push notifications without sending texts to the phone.

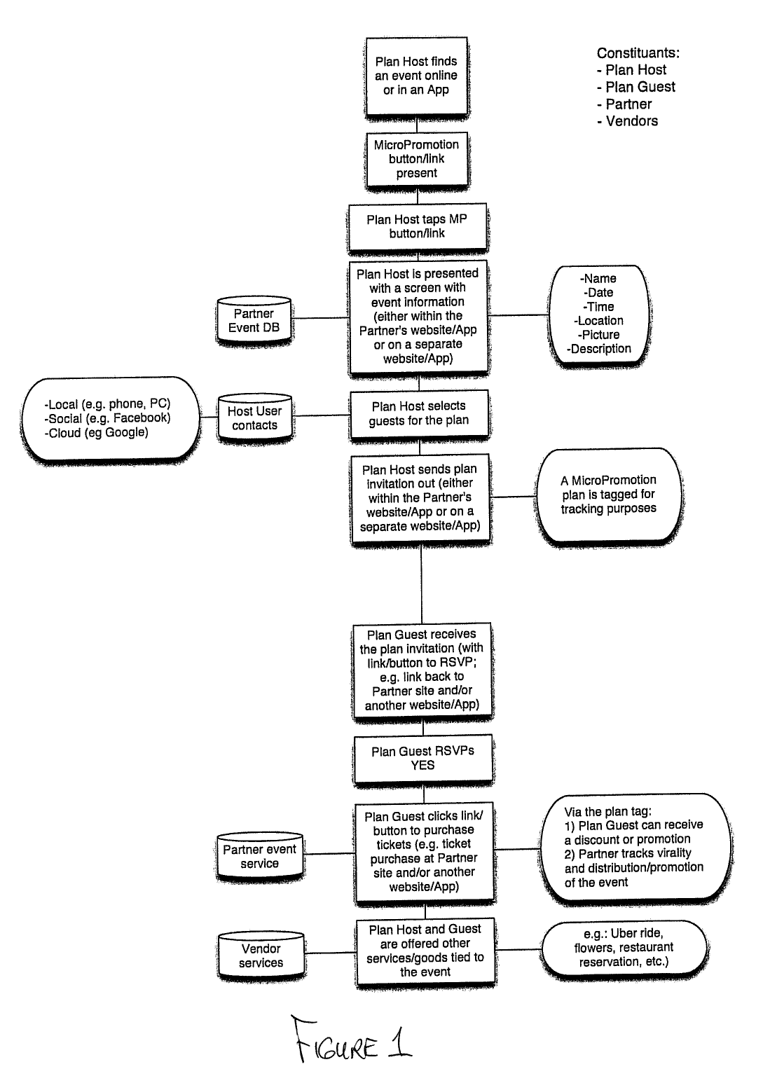

FIG. 1 is a flow diagram for event processing, under an embodiment. The MicroPromotion of events works between the following constituents, for example: Plan Host, Plan Guest, Partner and Vendors. Plan Host finds an event online or in an application that he or she would like to attend with others. The MicroPromotion button or link is present. Plan Host taps the MicroPromotion button or link. Plan Host is then presented with a screen with the event information, either within the Partner's website or application, or on a separate website or application. The Partner's Event Database includes the name, date, time, location, picture and description of the event.

Plan Host selects the guests he or she wants to invite for the plan via his or her contacts through a local connection (e.g., phone, PC, etc.), social connection (e.g., Facebook, etc.) or a cloud connection (e.g., Google, etc.). Other MicroPromotion members that Plan Host invites to a plan receive push notifications, while invitees or guests the Plan Host invites to plans who are not yet on MicroPromotion receive a text from the MicroPromotion cloud servers so that no texting charges are incurred. Plan Host sends out the plan invitation either within the Partner's website or application, or on a separate website or application. A MicroPromotion plan is tagged for tracking purposes.

Plan Guest receives the plan invitation with a link or button to RSVP, for example a link back to Partner's site with event service and/or another website or application. If Plan Guest RSVPs YES, then Plan Guest clicks a link or button to purchase tickets to the event, for example at Partner's site and/or another website or application. Via the plan's tag, Plan Guest can receive a discount or promotion, and Partner can track virality and distribution or promotion of the event.

Through Vendor services, Plan Host and Plan Guest are offered other goods and services tied to the event, such as an Uber ride, flowers, restaurant reservations, etc. Plan Host and Plan Guest can message, like and share photos all around the plan.

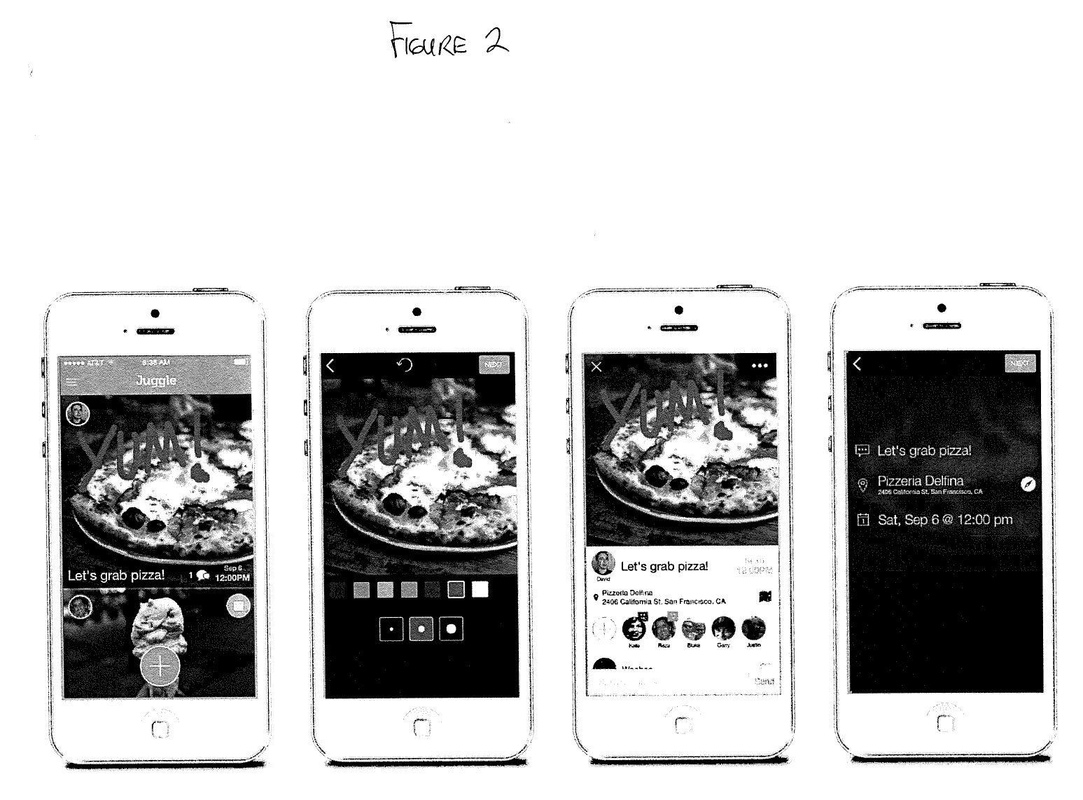

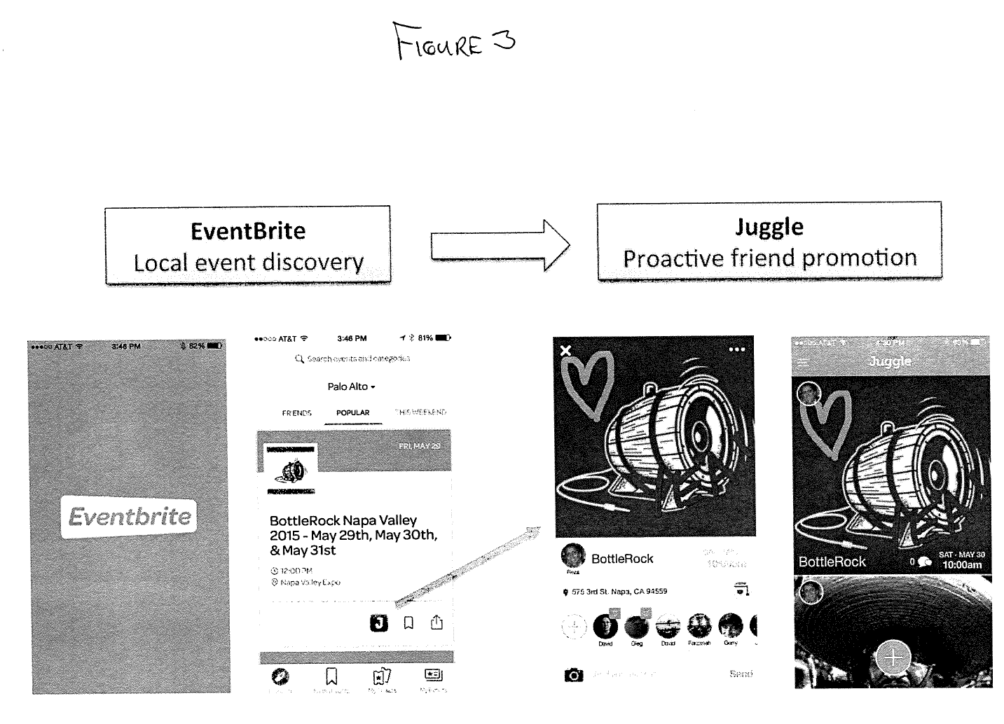

FIG. 2 shows example screenshots of the MicroPromotion event promotion process, under an embodiment. FIG. 3 is an example screen flow for event processing, under an embodiment. These example screenshots include use of photos and videos to express the user's personality and customized to fit the personal needs of its user, but embodiments are not so limited.

Computer systems and networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network as a component of embodiments may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The system of an embodiment can be a component of a single system, multiple systems, and/or geographically separate systems. The system can also be a subcomponent or subsystem of a single system, multiple systems, and/or geographically separate systems. The system can be coupled to one or more other components (not shown) of a host system or a system coupled to the host system.

One or more components of the embodiments and/or a corresponding system or application to which the system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the embodiments can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments and corresponding systems and methods is not intended to be exhaustive or to limit the systems and methods to the precise forms disclosed. While specific embodiments of, and examples for, the system and corresponding systems and methods are described herein for illustrative purposes, various equivalent modifications are possible within the scope of the systems and methods, as those skilled in the relevant art will recognize. The teachings of the system and corresponding systems and methods provided herein can be applied to other systems and methods, not only for the systems and methods described above. The elements and acts of the various embodiments described above can be combined to provide further embodiments. These and other changes can be made to the SocialParent system and corresponding systems and methods in light of the above detailed description.

What is claimed is:

1. A method comprising:
selecting an event on a first electronic site using a source device and integrating with a presentation of the event a selector for a micropromotion application;
automatically generating at the source device an invitation to the event in response to selection of the selector;
adding invitees to the invitation from at least one of a social media application and a contact application coupled to the source device;
configuring the invitation to include a reply link, wherein the reply link is configured to generate a reply to the source device, wherein the reply link is configured to generate, via one or more third party platforms, presentation of service offers at the source device and invitee devices of the invitees, wherein the service offers include offers of services of the event provider and services related to the event.

2. A system comprising:
a processor coupled to a memory device including a micropromotion application, wherein the processor is configured to:
select an event on a first electronic site using a source device and integrating with a presentation of the event a selector for the micropromotion application;
automatically generate at the source device an invitation to the event in response to selection of the selector;
add invitees to the invitation from at least one of a social media application and a contact application coupled to the source device;
configure the invitation to include a reply link, wherein the reply link is configured to generate a reply to the source device, wherein the reply link is configured to generate, via one or more third party platforms, presentation of service offers at the source device and invitee devices of the invitees, wherein the service offers include offers of services of the event provider and services related to the event.
